(19) United States
(12) Patent Application Publication
(10) Pub. No.: US 2009/0017920 A1
(43) Pub. Date: Jan. 15, 2009

(54) Front cover for a vane-type cam phaser

(76) Inventors: Michael J. Fox, Stafford, NY (US); Daniel R. Cuatt, Rush, NY (US)

Correspondence Address: DELPHI TECHNOLOGIES, INC., M/C 480-410-202, PO BOX 5052, TROY, MI, 48007, US

(21) Appl. No.: 11/827,810

(22) Filed: Jul. 13, 2007

(51) Int. Cl. F16P 1/04

(52) U.S. Cl. 464/1; 74/609

(57) ABSTRACT

A die cast aluminum front cover plate for application in a vane-type camshaft phaser includes a plurality of bores and a plurality of steel threaded inserts press fitted into the bores. Steel threaded inserts add the required strength to the stator bolt threads to enable a shorter thread engagement, which in turn enables a thinner aluminum front cover plate that may be packaged in tight applications where prior art aluminum front covers cannot be used due to their larger thickness. The steel threaded inserts not only provide a higher stiffness but also have a flanged shape that effectively spreads the clamp load generated during the tightening of the stator bolts further out preventing local clamp load points and, consequently, reducing cover deflection over the span of the front cover plate.

### TECHNICAL FIELD

The present invention relates to vane-type camshaft phasers for varying the phase relationship between crankshafts and camshafts in internal combustion engines; more particularly, to such phasers wherein a front cover plate clamps and seals against a stator; and most particularly, to a phaser having an improved front cover plate.

### BACKGROUND OF THE INVENTION

Camshaft phasers, also referred to herein simply as a cam phaser, for varying the phase relationship between the crankshaft and a camshaft of an internal combustion engine are well known. A prior art vane-type phaser generally comprises a plurality of outwardly extending vanes on a rotor interspersed with a plurality of inwardly extending lobes on a stator, forming alternating advance and retard chambers between the vanes and lobes. Engine oil is supplied via a multiport oil control valve (OCV), in accordance with an engine control module, to either the advance or the retard chambers as required to meet current or anticipated engine operating conditions. In a typical prior art vane-type camshaft phaser a front cover clamps and seals against a stator to prevent internal oil leakage across the rotor arms.

A first known front cover is made from powdered metal steel and typically requires significant secondary high-level precision machining, deburring, grinding, and cleaning. Packaging requirements necessitate the front cover geometry to have thin sections that are typically difficult to execute in powdered metal tooling. Especially a section of the cover that interfaces with a bias spring in the assembled cam phaser is prone to cracking because of its thin cross-section. Typically, powdered metal front covers are manufactured to have a thickness of about 7 mm.

A second known front cover is die cast from aluminum, requires secondary high-level precision machining, and includes a steel insert at a lock pin seat wear interface. Compared to the first known front cover, the aluminum front cover provides mass savings and is not prone to cracking at the interface with the bias spring. However, the aluminum die cast front cover must be thicker than the powdered metal steel front cover, since additional length for adequate stator bolt thread engagement into aluminum threads is needed. This additional length is not acceptable for some applications where packaging is tight. A typical minimum thickness for a die cast aluminum front cover where the threads are cut directly into the aluminum is about 9 mm. Furthermore, the aluminum front cover typically clamps against the stator by tightening the bolts in several locations thereby generating local clamp load points. These local clamp loads may cause deflection to occur in the span of the cover between the bolts. Such deflection of the front cover may reduce the effective clamp load between cover and stator and may increase localized end clearances on top of the rotor arm, which in turn may increase internal oil leakage across the rotor arms.

What is needed in the art is an improved front cover that fulfills the packaging requirements.

What is further needed in the art is an improved front cover that effectively spreads the clamp load further out, reducing cover deflection and improving the effective clamp load between cover and stator.

It is a principal object of the present invention to provide mass reduction while providing a rigid sealing surface.

It is a further object of the present invention to enable the use of aluminum for manufacturing the front cover of a cam phaser to be packaged in the tightest application by increasing the thread strength of the bolt bores.

### SUMMARY OF THE INVENTION

Briefly described, a vane-type camshaft phaser in accordance with the invention for varying the timing of combustion valves in an internal combustion engine includes a rotor having a plurality of vanes disposed in a stator having a plurality of lobes and a front cover plate that clamps and seals against the stator lobes. The front cover plate in accordance with the invention is die cast from aluminum followed by precision machining. The front cover plate includes four bolt bores for receiving stator bolts and a well that receives a hardened, ground bushing functioning as a lock pin seat. Formed steel threaded inserts are press fitted into the bolt bores of the aluminum front cover plate. This adds the required strength to the stator bolt threads to enable a shorter thread engagement, which in turn enables a thinner aluminum front cover plate that may be packaged in tight applications where prior art aluminum front covers cannot be used due to their greater thickness.

The steel threaded inserts not only provide a higher stiffness but also have a flanged shape that effectively spreads the clamp load generated during the tightening of the stator bolts further out preventing local clamp load points and, consequently, reducing cover deflection over the span of the front cover plate. Reduced cover deflection results in an improved effective clamp load between cover and stator and reduced oil leakage from valve timing advance and valve timing retard chambers formed by the rotor and the stator.

Furthermore, by utilizing steel inserts having a higher strength than aluminum materials, mass savings, and consequently manufacturing costs savings, compared to prior art powdered metal front covers are achieved by enabling the use of aluminum as material for the front cover plate while fulfilling packaging requirements for tight applications. Still further, the use of steel threaded inserts in accordance with the present invention enables the design of an aluminum die cast front cover plate that has the potential to work with the currently existing envelope at current or lower costs and that enables the use of the existing bias spring.

Therefore, the addition of steel threaded inserts pressed into the aluminum die cast front cover plate in accordance with the invention solves the problem of aluminum threat strength and localized clamp loads and, therefore, overcomes the shortcomings of prior art aluminum die cast front covers.

### BRIEF DESCRIPTION OF THE DRAWINGS

The present invention will now be described, by way of example, with reference to the accompanying drawings, in which:

FIG. 1 is an exploded isometric view of a vane-type camshaft phaser in accordance with the invention;

FIG. 2 is an exploded isometric top view of a front cover plate in accordance with the invention;

FIG. 3 is an isometric top view of the front cover plate with steel threaded inserts installed in accordance with the invention;

FIG. 4 is an exploded isometric bottom view of the front cover plate in accordance with the invention;

FIG. 5 is an isometric bottom view of the front cover plate with steel threaded inserts installed in accordance with the invention; and

FIG. 6 is a cross-sectional view of the front cover plate taken through a bore and a lock pin seat in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

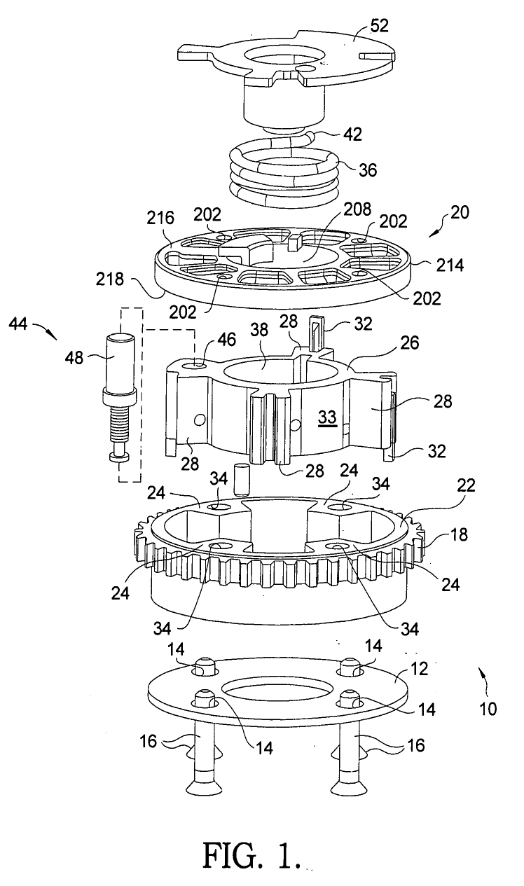

Referring to FIG. 1, a vane-type cam phaser 10 in accordance with the invention includes a rear cover 12 having bores 14 for receiving bolts 16. The heads of bolts 16 are received in countersinks in rear cover 12 and the threaded ends of bolts 16 are received in front cover plate 20. A pulley or sprocket 18 is formed integrally with a stator 22, also referred to as a stator/sprocket. Pulley or sprocket 18 is typically used for engaging a timing chain or belt (not shown) operated by an engine crankshaft (not shown). Stator 22 is provided with a plurality of inwardly extending lobes 24 circumferentially spaced apart for receiving a rotor 26 including outwardly extending vanes 28 which extend into the spaces between lobes 24. Hydraulic advance and retard chambers are thus formed between lobes 24 and vanes 28 as known in the art. Each rotor vane 28 is provided with an axial groove along the vane tip for receiving a resilient seal element 32 for sealingly wiping a cylindrically concave inner wall of stator 22. Likewise, each stator lobe 24 may be provided with an axial groove along the lobe tip for receiving a resilient seal element 32 for sealingly wiping a cylindrically convex outer wall 33 of the hub of rotor 26.

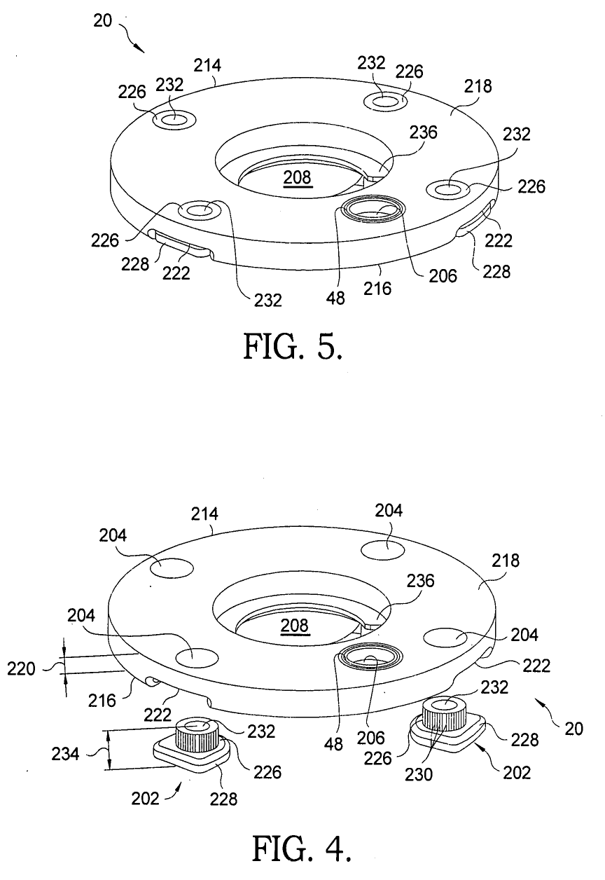

Rear cover 12 and front cover plate 20 clamp against stator lobes 24 at opposite sides. Bolts 16 extend through bores 14 included in rear cover 12 and through bores 34 positioned in stator lobes 24 and the threaded ends of bolts 16 are received in threaded inserts 202 press fitted into bores 204 of cover plate 20. A hub of a target wheel 52 passes through front cover plate 20 and is fixed to rotor 21 for rotation therewith. Target wheel 52 spins in front of a sensor creating timed pattern of high/low signals for the purpose of sensing and/or controlling the position of phaser 10. A coiled bias spring 36 is disposed in a central well 38 formed in rotor 26 and is anchored to front cover plate 20 by tang 42 for urging rotor 26 to a predetermined rest position relative to the position of the stator, for example, fully retarded at engine shutdown. A locking pin mechanism 44 is received in a longitudinal bore 46 formed in an oversize vane 28 of rotor 26. A well 206 formed in front cover plate 20 (shown in FIGS. 4 through 6) receives bushing 48 of locking pin mechanism 44 and is utilized as lock pin seat. Locking pin mechanism 44 may rotationally lock and unlock rotor 26 to and from stator 22. In installation to an engine camshaft, cam phaser 10 is secured via a central bolt (not shown).

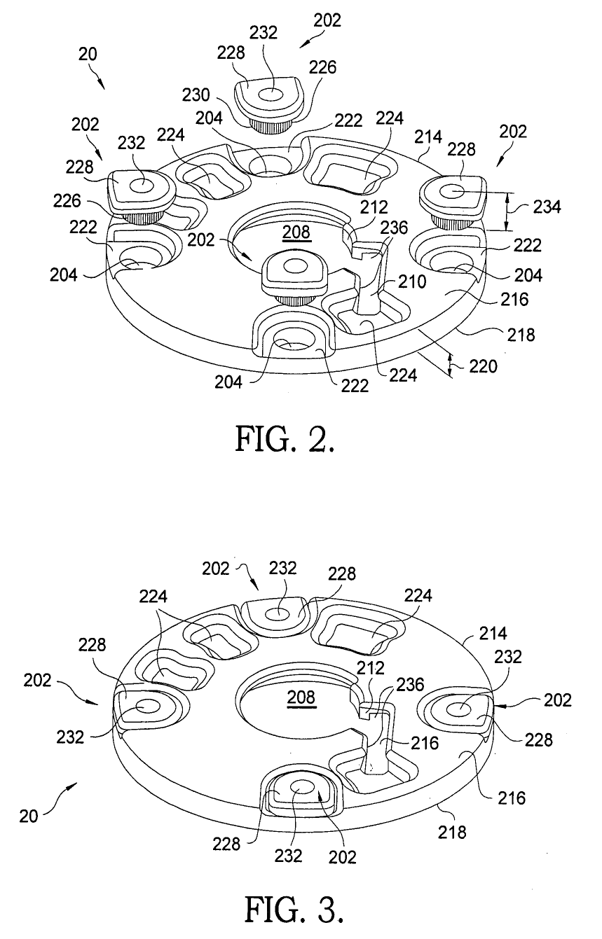

Referring now to FIGS. 2 and 3, an improved die cast aluminum front cover plate 20 of a camshaft phaser 10 in accordance with the invention has a generally circular shape with a generally circular central opening 208 and extends longitudinally from an outer surface 216 to an inner surface 218 for a thickness 220. A groove 210 for receiving tang 42 of bias spring 36 (FIG. 1) extends for a distance from central opening 208 towards the outer perimeter 214 of front cover plate 20 and is formed in outer surface 216 during the die casting process and later machined. A window 236 leading to groove 210 is machined into front cover plate 20. A lip 212 for guiding bias spring 36 extends into central opening 208 proximate to groove 210. Front cover plate 20 includes bores 204 positioned in indentations 222 and proximate to outer perimeter 214. Bores 204 are also positioned to be in line with stator bores 34 included in stator lobes 24, as shown in FIG. 1. If stator 22 includes four lobes 24 and thus four bores 34 as shown in FIG. 1, front cover plate 20 includes four bores 204 for receiving four bolts 16. In a currently preferred embodiment, bores 204 are machined into front cover plate 20. Bores 204 and indentations 222 are designed to receive steel threaded inserts 202. Bore 204 receives knurled shaft 226 and flange 228 rests in indentation 222. Additional indentations 224 in outer surface 216 may be included in front cover plate 20 to enable mass reduction while still providing a rigid sealing surface.

Threaded inserts 202 include shaft 226, flange 228, and threaded axial bore 232. Threaded inserts 202 are in a currently preferred embodiment manufactured from steel. The shaft 226 is provided with knurls 230, a series of small ridges or grooves on the surface of shaft 226, that enable to press fit steel threaded inserts 202 into bores 204. Knurls 230 support press fitting steel threaded inserts 202 into bores 204 and, thus, the convenient subassembly of front cover plate 20, and eliminate the need to grind or otherwise extensively machine the inner surface of bores 204 to receive the inserts 202. Flange 228 horizontally extends from shaft 226 orthogonally in all directions.

While flange 228 is shown to have a “D” shape, flange 228 may have any desired shape, such as circular, rectangular, square, hexagonal etc. Threaded bore 232 extends through shaft 226 and flange 228 and receives the threaded end of bolt 16 shown in FIG. 1. The length 234 of threaded bore 232 and, therefore, the length of steel threaded insert 20, is determined by the size of bolts 16, since the thread length needs to have at least the same value as the diameter of the received bolt. Thus, for example, if bolt 16 is a size M6 with a diameter of 6 mm (millimeters), length 234 of threaded bore 232 preferably should be at least 6 mm. Since indentations 222 are designed such that flange 228 of steel threaded insert 202 is level with outer surface 216 of front cover plate 20 when installed, thickness 220 of cover plate 20 has nominally the same value as length 234 of threaded bore 232 and, thus, of steel threaded insert 202. Consequently, thickness 220 of front cover plate 202 needs to be at least 6 mm if, for example, M6 bolts 16 are used. With a minimal possible thickness 220 of 6 mm, front cover plate 20 is suitable for applications where packaging requirements necessitate a maximum thickness 220 of, for examples 7 mm.

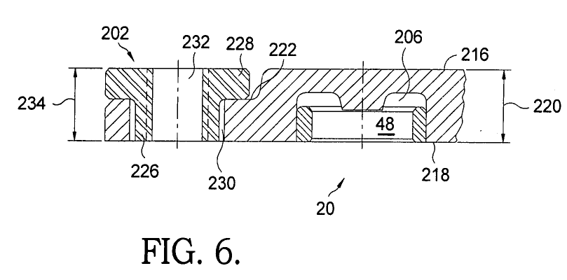

Referring now to FIGS. 4 through 6, front cover plate 20 includes a well 206 formed in inner surface 218 for receiving bushing 48 of locking pin mechanism 44 (shown in FIG. 1). Well 206 is utilized as a lock pin seat for locking pin mechanism 44. Since camshaft phaser 10 is exemplary shown in FIG. 1 to include only one locking pin mechanism 44, front cover plate 20 is shown in FIGS. 5 and 6 to include only one well 206. As can be seen, well 206 is positioned in relative close proximity to one of bores 204. As can be seen in FIG. 6, cover plate 20 is designed such that steel threaded insert 202 can be positioned in indentation 222 formed in outer surface 216 without interfering with well 206 formed in inner surface 218. This enables the use of front cover plate 20 with currently existing manufacturing envelopes.

By utilizing steel threaded inserts 202 as in a currently preferred embodiment the problem of aluminum thread strength found in prior art die cast aluminum front covers is solved and, consequently, a more compact (smaller thickness 220) die cast aluminum front cover plate 20 is enabled, allowing for packaging of cam phaser 10 in tighter applications where prior art aluminum front covers will not fit. By allowing for a smaller thickness 220 steel threaded inserts 202 enable a mass savings compared to prior art front covers.

Furthermore, by horizontally extending shaft 226 and, thus, diameter of bore 204, flange 228 effectively spreads a clamp load created during tightening of bolts 16 beyond the diameter of bolt 16. Consequently, utilizing steel threaded inserts 202 enables the clamp load to be evenly distributed throughout an area surrounding bore 204 preventing local load points. Thus, deflection of front cover plate 20 is reduced and the overall effective clamping load of the front cover against the stator, compared to prior art die cast aluminum front covers, is improved.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A die cast aluminum front cover plate for application in a vane-type camshaft phaser, comprising:
a plurality of bores; and
a plurality of steel threaded inserts press fitted into said bores, wherein the number of said steel threaded inserts matches the number of said bores.

2. The front cover plate in accordance with claim 1, further comprising an outer surface extending axially from an inner surface for a thickness, wherein the length of said steel threaded inserts is nominally identical with said thickness.

3. The front cover plate in accordance with claim 2 wherein said thickness is at least equal to a diameter of said bores.

4. The front cover plate in accordance with claim 1, further comprising a plurality of indentations in an outer surface proximate to an outer perimeter, wherein said indentations include said bores.

5. The front cover plate in accordance with claim 1, wherein said steel threaded inserts include a shaft, a flange, and a threaded axial bore, wherein said shaft is received in said bore, and wherein said flange horizontally extends from said shaft orthogonally in all directions.

6. The front cover plate in accordance with claim 5, wherein said shaft is provided with knurls, and wherein said knurls support press fitting said steel threaded inserts into said bores.

7. The front cover plate in accordance with claim 1, wherein said steel threaded inserts receive bolts that clamp said front cover plate against a stator of said camshaft phaser.

8. The front cover plate in accordance with claim 1, further including a groove that receives a tang of a bias spring, and a lip that both guide said bias spring.

9. The front cover plate in accordance with claim 1, wherein the number of said bores and said steel threaded inserts matches the number of bolts used for assembly of said camshaft phaser.

10. The front cover plate in accordance with claim 1, further including a well integrated into an inner surface, wherein said well receives a bushing for a locking pin mechanism included in said camshaft phaser.

11. The front cover plate in accordance with claim 10, wherein said well is formed in an inner surface of said front cover plate and is positioned proximate to one of said bores, and wherein said steel threaded insert is press fitted into said one bore without interfering with said well.

12. A vane-type camshaft phaser for advancing and retarding the timing of valves of an internal combustion engine, comprising:
a rear cover including first bores;
a stator including inwardly extending lobes having second bores, wherein said second bores are aligned with said first bores;
a front cover plate including third bores that include press fitted threaded inserts, wherein said third bores are aligned with said second bores; and
bolts including heads and threaded ends opposite from said heads, wherein said threaded inserts receive said threaded ends, and wherein said bolts clamp said rear cover and said front cover against said stator at opposite sites.

13. The vane-type camshaft phaser in accordance with claim 12, further comprising a rotor disposed within said stator and including outwardly extending vanes that extend into spaces between said lobes.

14. The vane-type camshaft phaser in accordance with claim 12, further comprising a locking pin mechanism including a bushing, wherein said bushing is received by a well formed in an inner surface of said front cover plate.

15. The vane-type camshaft phaser in accordance with claim 12, further comprising a coiled bias spring anchored to said front cover plate by a tang.

16. The vane-type camshaft phaser in accordance with claim 12, further comprising a plurality of indentations in an outer surface proximate to an outer perimeter, wherein said indentations include said third bores, and wherein said threaded inserts include a knurled shaft, a flange, and a threaded axial bore, wherein said shaft is received in said third bores, and wherein said flange extends orthogonally from said shaft within said indentations.

17. The vane-type camshaft phaser in accordance with claim 12, wherein a thickness of said front cover plate is identical with a length of said steel threaded inserts, and wherein said thickness of said front cover plate is at least equal to a diameter of said threaded ends of the bolts.

18. A method for clamping a front cover plate against a stator of a vane-type camshaft phaser, comprising the steps of:
fabricating said front cover plate from aluminum;
forming a plurality of holes into said front cover plate;
inserting threaded inserts into said holes;
extending bolts having a head and a threaded end through bores in said stator; and
receiving said threaded ends of said bolts in said threaded inserts.

19. The method according to claim 18, further including the steps of:
forming a plurality of indentation in an outer surface of said front cover plate proximate to an outer perimeter;
machining one of said holes in each of said indentations;
forming said threaded inserts to include a knurled shaft, a flange and a threaded axial bore; and
press fitting said knurled shaft into said hole thereby resting said flange in said indentation.

20. The method according to claim 18, further including the steps of:
tightening said bolts;
creating a clamp load; and
spreading said clamp load out beyond a diameter of said bolts.

21. The method according to claim 18, further including the steps of:
fabricating said threaded inserts to have the same length as a diameter of said threaded ends of said bolts; and
forming said front cover plate to have a thickness that is at least equal to said diameter of said threaded ends of said bolts.
